(19) United States
(12) Patent Application Publication
(10) Pub. No.: US 2024/0103884 A1
(43) Pub. Date: Mar. 28, 2024

(54) PREDICTIVE LEARNING FOR THE ADOPTION OF SYSTEM CHANGES

(71) Applicant: International Business Machines Corporation, Armonk, NY (US)

(72) Inventors: Tram Thi Mai Nguyen, Santa Clara, CA (US); Prasoon Sinha, Melbourne (AU); Lee Jason Sanders, West Sussex (GB); James Raimondo, Santa Clara, CA (US)

(21) Appl. No.: 17/935,264

(22) Filed: Sep. 26, 2022

(51) Int. Cl. G06F 9/445; G06F 8/65

(52) U.S. Cl. CPC G06F 9/44505; G06F 8/65

(57) ABSTRACT

According to an aspect, a computer-implemented method includes receiving a request to evaluate an update to a computing system and obtaining a current configuration of the computing system. Aspects also include identifying one or more changes that the update will require to the current configuration and obtaining performance data corresponding to the one or more changes from a data repository. Aspects further include calculating a confidence score for the update based on the performance data and providing the computing system with the confidence score.

### BACKGROUND

The present invention generally relates to computer systems, and more specifically, to computer systems, computer-implemented methods, and computer program products for using predictive learning to evaluate changes to a computing system.

In general, computing systems include a large number of different components that interact with each other in multiple ways. These components include hardware devices, software, and the like. Updates are often made to the firmware associated with the hardware devices and to the software components. Applying these updates to the various components of the computing system often causes temporary systems outages during the update and can also lead to undesired changes to the operation or performance of the computing system.

As a result, users and systems administrators are often forced to choose between applying new updates that may cause undesired changes to the operation or performance of the computing system or continuing to use outdated software.

### SUMMARY

Embodiments of the present invention are directed to method for evaluating an update to a computing system. According to an aspect, a computer-implemented method includes receiving a request to evaluate an update to a computing system and obtaining a current configuration of the computing system. The method also includes identifying one or more changes that the update will require to the current configuration and obtaining performance data corresponding to the one or more changes from a data repository. The method further includes calculating a confidence score for the update based on the performance data and providing the computing system with the confidence score.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system for use in conjunction with one or more embodiments of the present invention;

FIG. 3 is a block diagram of a database for use in conjunction with one or more embodiments of the present invention;

FIG. 4 is a flowchart of a method for evaluating an update to a computing system in accordance with one or more embodiments of the present invention; and

FIG. 5 is a flowchart of another method for evaluating an update to a computing system in accordance with one or more embodiments of the present invention.

### DETAILED DESCRIPTION

As discussed above, applying updates to components of a computing system can often cause a temporary systems outage during the update and can also lead to undesired changes to the operation or performance of the computing system. One or more embodiments of the present invention include methods, systems, and computer program products for using predictive learning to evaluate changes to a computing system. In exemplary embodiments, by using predictive learning to evaluate changes to a computing system a user, or system administrator, will be able to more accurately assess the risks associated with updating a component of the computing system.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the predictive learning to evaluate changes to a computing system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

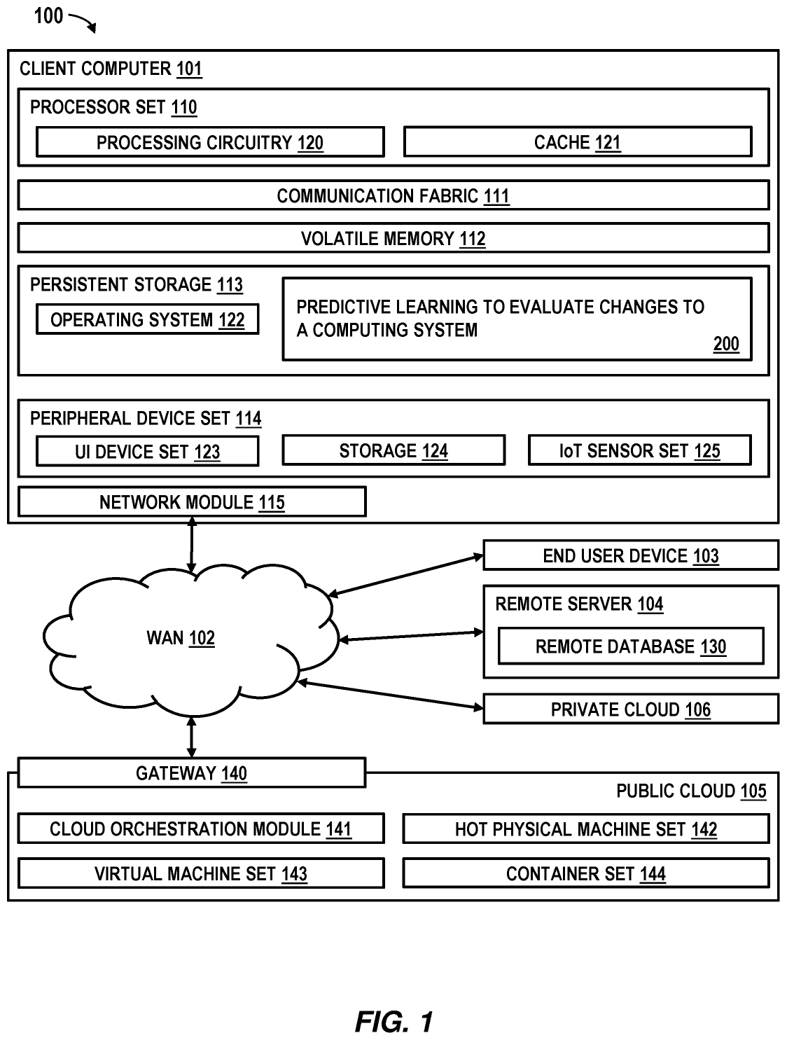

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

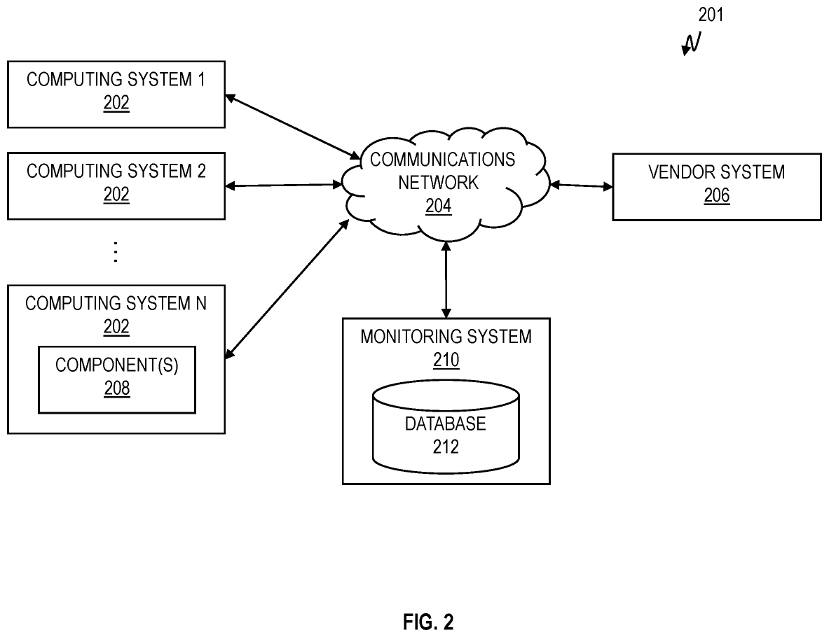

Referring now to FIG. 2, a block diagram of a system 201 for use in conjunction with one or more embodiments of the present invention is shown. In exemplary embodiments, the system 201 includes a plurality of computing systems 202 that each include a plurality of components 208. In exemplary embodiments, the computing systems 202 may be a personal computer, a mobile device, a computer 101 as shown in FIG. 1, or the like. In exemplary embodiments, the components 208 include one or more pieces of hardware and/or one or more pieces of software. The system 201 also includes a vendor system 206 that is configured to provide an update to one or more of the components 208 on the plurality of computing systems 202.

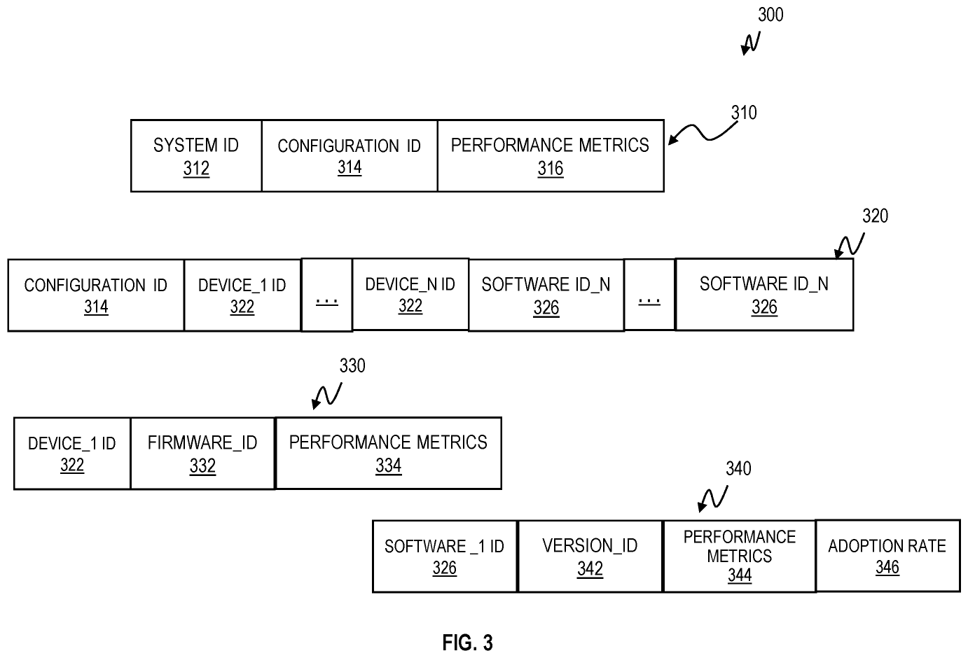

In exemplary embodiments, the system 201 also includes a monitoring system 210 that includes a database 212, which is described in more detail herein with reference to FIG. 3. In exemplary embodiments, the computing system 202 is embodied in a computer 101 as shown in FIG. 1. The plurality of computing systems 202, the vendor system 206, and the monitoring system 210 are configured to communicate with one another via a communications network 204, such as the Internet.

In exemplary embodiments, the monitoring system 210 is configured to receive and store, in the database 212, data regarding a configuration and performance of each of the plurality of computing systems 202. In general, the configuration of each computing system 202 includes an identification of the components 208 of the computing system and identification of version of the software and/or firmware of each component. In exemplary embodiments, the monitoring system 210 is further configured to evaluate a proposed change to the configuration of a component 208 of a computing system 202 based on changes in performance data obtained from other computing systems 202, which have the same or similar configurations, that have previously made the proposed change.

Referring now to FIG. 3, a block diagram of a database 300 for use in conjunction with one or more embodiments of the present invention is shown. As illustrated, the database 300 includes a first table 310 that includes a system identification field 312, a configuration identification field 314, and a performance metric(s) field 316. In exemplary embodiments, the first table 310 is configured to store the performance metrics for each configuration of a computing system as the computing system gets updated over time.

The database 300 includes a second table 320 that includes a configuration identification field 314, a plurality of device identification fields 322 and a plurality of software identification fields 326. In exemplary embodiments, the second table 320 is configured to store the details corresponding to each configuration of a computing system, including the hardware devices and software installed on the computing system.

The database 300 includes a third table 330 that includes a device identification field 322, a firmware identification field 332, and a performance metric field 334. In exemplary embodiments, the third table 330 is configured to store the performance data for a hardware device corresponding to each version of the firmware of the hardware device.

The database 300 includes a fourth table 340 which includes a software identification field 326, a version identification field 342, a performance metric field 344, and an adoption rate field 346. In exemplary embodiments, the fourth table 340 is configured to store the performance data for each version of a piece of software and to store the adoption rate of each version of the software. The adoption rate is the percentage of the computing systems that have the software that has been upgraded to the corresponding version of the software.

As will be appreciated by those of ordinary skill in the art, the database 300 may include additional tables and fields other than those shown in FIG. 3 and the tables and fields shown are meant to be exemplary in nature and not limiting in any way.

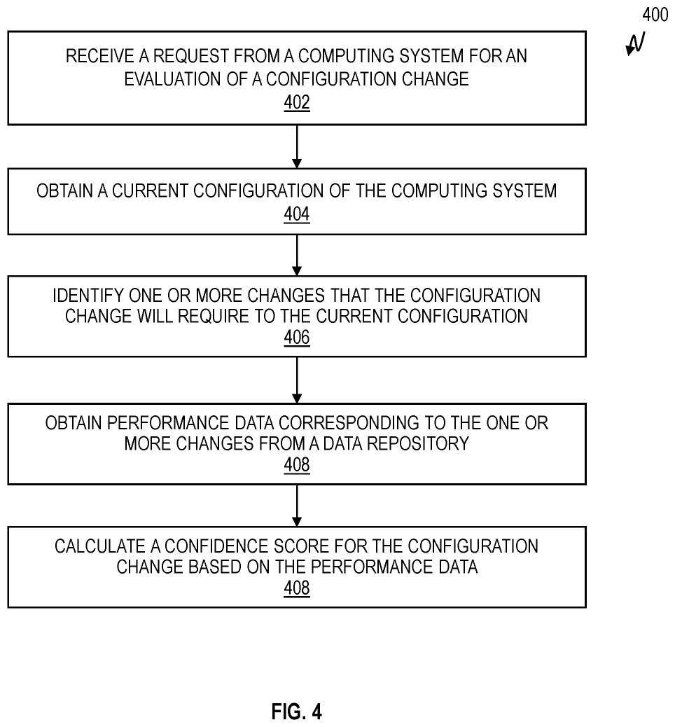

Referring now to FIG. 4, a flowchart of a method 400 for evaluating an update to a computing system in accordance with one or more embodiments of the present invention is shown. In exemplary embodiments, the method 400 is performed by a monitoring system 210 as shown in FIG. 2. The method 400 includes receiving, from a computing system, a request to evaluate an update to the computing system. In exemplary embodiments, the request includes a system identification number that corresponds to the computing system and optionally a configuration identification number that corresponds to a current configuration of the computing system. In exemplary embodiments, the update indicates a component of the computing system to be upgraded, i.e., a software identification or a device identification, and a current and proposed version corresponding to the software or firmware.

Next, as shown at block 404, the method 400 also includes obtaining a current configuration of the computing system. In one embodiment, the current configuration of the computing system is obtained from the request. In another embodiment, the current configuration of the computing system is obtained from a data repository, such as database 300 shown in FIG. 3, based on the system identification number that corresponds to the computing system. Next, as shown at decision block 406, the method 400 includes determining whether the current configuration is compatible with the update. If the current configuration is not compatible with the update, the method 400 proceeds to block 408 and notifies the system administrator or user of changes to the current configuration that are needed to apply the update.

If the current configuration is compatible with the update, the method 400 proceeds to block 410 and includes identifying one or more changes that the update will require to the current configuration. In exemplary embodiment, the one or more changes include the requested change and one or more additional changes that will be required to implement the requested change. In one example, a requested change to a first piece of software may require that another piece of software or hardware be updated or changed to properly support the requested change. In exemplary embodiments, the update includes an identification of a component of the computing system to be updated and identifying the one or more changes that the update will require to the current configuration includes identifying at least one additional component of the computing system that will be impacted by the update.

Next, as shown at block 412, the method 400 includes obtaining performance data corresponding to the one or more changes from a data repository. In exemplary embodiments, the data repository includes performance data obtained from a plurality of computing systems, including the computing system. The performance data includes observed performance metrics associated with multiple configurations of each of the plurality of computing systems. Each of the multiple configurations includes an identification of one or more pieces of software, a version of the one or more pieces of software, one or more pieces of hardware, and a firmware version of the one or more pieces of hardware.

The method 400 also includes calculating a confidence score for the update based on the performance data, as shown at block 414. In exemplary embodiments, the confidence score is based at least in part on a change in performance metrics of a second computing system resulting from the one or more changes being made to the second computing system. In one embodiment, the confidence score is further based on a number of computing systems that have applied the one or more changes. Once the confidence score has been determined, it is provided to the computing system so that the user of the computing system can determine whether to perform the requested update.

In exemplary embodiments, the confidence score is provided to the requesting computing system along with one or more pieces of data that were used to determine the confidence score. In one example, the confidence score for applying a software update is provided with an adoption rate for the new version of the software. In another example, the confidence score is provided with an average time that a computing system was down while applying the requested update. In a further example, the confidence score is provided with a change in one or more performance metrics of computing systems that occurred as a result of performing the requested update.

In one embodiment, the calculation of the confidence score is based on one or more of an expected downtime associated with performing the requested update, an expected change in performance of the computing system as a result of the requested update, an adoption rate of the requested update, a number of reported bugs associated with the requested update, and the like.

Next, as shown at block 416, the method 400 includes providing an update runbook for the update to the system administrator or user. The update runbook includes the required steps to perform the update. In one embodiment, the update runbook includes an indication of the interdependency of the of the steps required to perform the update. The update runbook can also include runtime information, such as how long it took to apply the changes in similar systems.

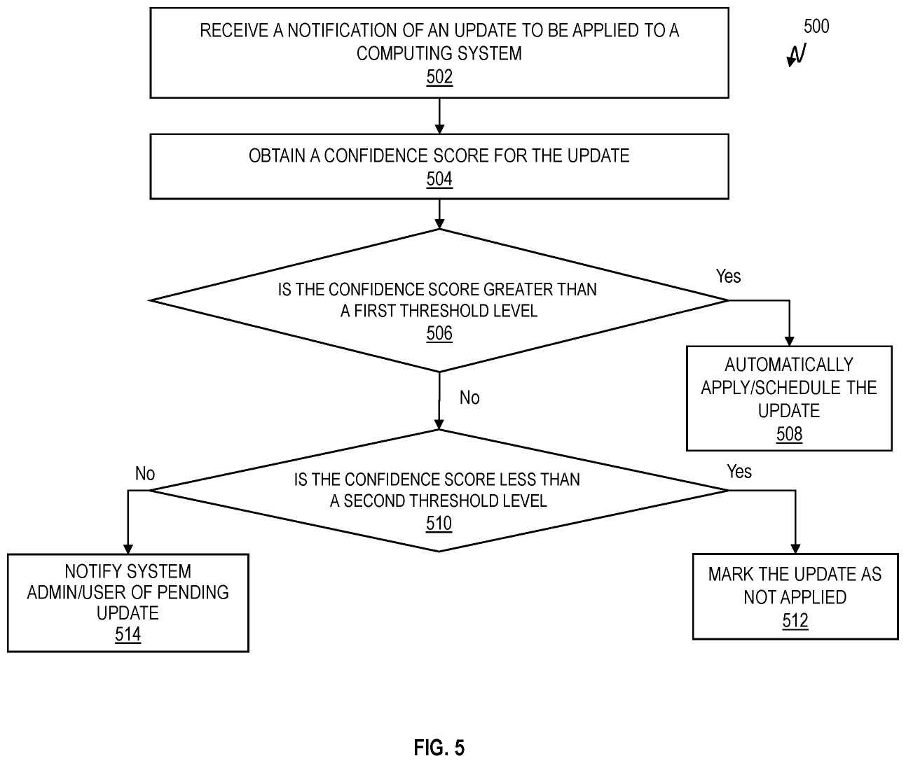

Referring now to FIG. 5, a flowchart of a method 500 for evaluating a update to a computing system in accordance with one or more embodiments of the present invention is shown. In exemplary embodiments, the method 500 is performed by a computing system 202 as shown in FIG. 2. The method 500 includes receiving a notification of an update to be applied to a computing system, as shown at block 502. In one embodiment, the computing system receives the notification of an update to a component of the computing system from a vendor corresponding to the component. Next, as shown at block 504, the method 500 includes obtaining a confidence score for the update. In one embodiment, the confidence score is obtained via a method shown in FIG. 4. In another embodiment, the computing system may calculate the confidence score based on data obtained from a database maintained by a monitoring system, such as the one shown in FIG. 2.

Once the confidence score for the update has been obtained, the method 500 includes determining whether the confidence score is greater than a first threshold level, as shown at decision block 506. Based on a determination that the confidence score is greater than the first threshold level, the method 500 proceeds to block 508 and automatically applies the update or schedules the update for the application. In exemplary embodiments, the first threshold level is set by a user or systems administrator of the computing system and represents a minimum confidence score at which the update is considered to be safe to apply to the computing system.

Based on a determination that the confidence score is not greater than the first threshold level, the method 500 proceeds to decision block 510 and determines whether the confidence score is less than a second threshold level. Based on a determination that the confidence score is less than the second threshold level, the method 500 proceeds to block 512 and marks the update as not applied. Otherwise, the method 500 proceeds to block 514 and notifies the user, or system administrator, of the computing system of the pending update. In one embodiment, the notification includes the confidence score and one or more pieces of data that were used to determine the confidence score. In exemplary embodiments, the second threshold level is set by a user, or systems administrator, of the computing system and represents a confidence score at which the update is considered to be unsafe to apply to the computing system. In exemplary embodiments, when the confidence score is between the second threshold level and the first the user may rely on the one or more pieces of data that were used to determine the confidence score to determine whether, and when, to apply the update to the computing system.

Technical advantages and benefits include methods, systems, and computer program products that allow a systems user or administrator to more fully understand the risks and expected benefits associated with applying an update to a component of a computing system prior to performing the installation by calculating a confidence score for the update based on data collected from other computing systems that have applied the update. Benefits also include allowing users to determine the time required to apply an update to the computing system and schedule the change window accordingly. In addition, the confidence score and update runbook give users concrete data for use in their decision making to ensure they have the reliability and availability of systems with high confidence.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, from a computing system, a request to evaluate an update to the computing system;
obtaining a current configuration of the computing system;
identifying one or more changes that the update will require to the current configuration;
obtaining performance data corresponding to the one or more changes from a data repository;
calculating a confidence score for the update based on the performance data; and
providing the computing system with the confidence score.

2. The computer-implemented method of claim 1, wherein the update includes at least one of:
an update to a software installed on the computing system;
an update to a firmware of a hardware device that is part of the computing system; and
an update to the hardware device that is part of the computing system.

3. The computer-implemented method of claim 1, wherein the data repository includes performance data obtained from a plurality of computing systems, including the computing system, and wherein the performance data includes observed performance metrics associated with multiple configurations of each of the plurality of computing systems.

4. The computer-implemented method of claim 3, wherein each of the multiple configurations includes an identification of one or more pieces of software, a version of the one or more pieces of software, one or more pieces of hardware, and a firmware version of the one or more pieces of hardware.

5. The computer-implemented method of claim 1, wherein the update includes an identification of a component of the computing system to be updated and identifying the one or more changes that the update will require to the current configuration includes identifying at least one additional component of the computing system that will be impacted by the update.

6. The computer-implemented method of claim 1, wherein the confidence score is based at least in part on a change in performance metrics of a second computing system resulting from the one or more changes being made to the second computing system.

7. The computer-implemented method of claim 1, wherein the confidence score is further based on a number of computing systems that have applied the one or more changes.

8. A system comprising:
a memory having computer readable instructions; and
one or more processors for executing the computer readable instructions, the computer readable instructions controlling the one or more processors to perform operations comprising:
receiving a request to evaluate an update to a computing system;
obtaining a current configuration of the computing system;
identifying one or more changes that the update will require to the current configuration;
obtaining performance data corresponding to the one or more changes from a data repository;
calculating a confidence score for the update based on the performance data; and
providing the computing system with the confidence score.

9. The system of claim 8, wherein the update includes at least one of:
an update to a software installed on the computing system;
an update to a firmware of a hardware device that is part of the computing system; and
an update to the hardware device that is part of the computing system.

10. The system of claim 8, wherein the data repository includes performance data obtained from a plurality of computing systems, including the computing system, and wherein the performance data includes observed performance metrics associated with multiple configurations of each of the plurality of computing systems.

11. The system of claim 10, wherein each of the multiple configurations includes an identification of one or more pieces of software, a version of the one or more pieces of software, one or more pieces of hardware, and a firmware version of the one or more pieces of hardware.

12. The system of claim 8, wherein the update includes an identification of a component of the computing system to be updated and identifying the one or more changes that the update will require to the current configuration includes identifying at least one additional component of the computing system that will be impacted by the update.

13. The system of claim 8, wherein the confidence score is based at least in part on a change in performance metrics of a second computing system resulting from the one or more changes being made to the second computing system.

14. The system of claim 8, wherein the confidence score is further based on a number of computing systems that have applied the one or more changes.

15. A computer program product comprising a computer readable storage medium having program instructions embodied therewith, the program instructions executable by a processor to cause the processor to perform operations comprising:
receiving a request to evaluate an update to a computing system;
obtaining a current configuration of the computing system;
identifying one or more changes that the update will require to the current configuration;
obtaining performance data corresponding to the one or more changes from a data repository;
calculating a confidence score for the update based on the performance data; and
providing the computing system with the confidence score.

16. The computer program product of claim 15, wherein the update includes at least one of:
an update to a software installed on the computing system;
an update to a firmware of a hardware device that is part of the computing system; and
an update to the hardware device that is part of the computing system.

17. The computer program product of claim 15, wherein the data repository includes performance data obtained from a plurality of computing systems, including the computing system, and wherein the performance data includes observed performance metrics associated with multiple configurations of each of the plurality of computing systems.

18. The computer program product of claim 17, wherein each of the multiple configurations includes an identification of one or more pieces of software, a version of the one or more pieces of software, one or more pieces of hardware, and a firmware version of the one or more pieces of hardware.

19. The computer program product of claim 15, wherein the update includes an identification of a component of the computing system to be updated and identifying the one or more changes that the update will require to the current configuration includes identifying at least one additional component of the computing system that will be impacted by the update.

20. The computer program product of claim 15, wherein the confidence score is based at least in part on a change in performance metrics of a second computing system resulting from the one or more changes being made to the second computing system.
